(19) United States
(12) Patent Application Publication
(10) Pub. No.: US 2023/0335939 A1
(43) Pub. Date: Oct. 19, 2023

(54) ANTI-REMOVAL DEVICE FOR A SINGLE PAIR ETHERNET CONNECTOR ASSEMBLY

(71) Applicant: CommScope Technologies LLC, Hickory, NC (US)

(72) Inventors: Zhihui LIU, Jiangsu (CN); Hui LI, Suzhou (CN); Jing WANG, Jiangsu (CN)

(21) Appl. No.: 18/300,793

(22) Filed: Apr. 14, 2023

(30) Foreign Application Priority Data
Apr. 15, 2022 (CN) 202220881293.9

(51) Int. Cl. H01R 13/514; H01R 13/639

(52) U.S. Cl. CPC H01R 13/514; H01R 13/6397; H01R 24/68

(57) ABSTRACT

The present disclosure relates to an anti-removal device for a single pair Ethernet connector assembly, including a protective cover, the protective cover having a hollow box shape and having a through-hole, the protective cover being constructed to be fixated on the top surface of the male connector, the protective cover and the female connector or the coupler jointly enclosing the elastic locking piece and the elastic unlocking piece when the male connector and the female connector or the coupler are connected with each other; a unlocking rod, the unlocking rod having an elongated shape and being able to pass through the through-hole of the protective cover to approach the elastic unlocking piece to unlock the male connector from the female connector or the coupler.

### RELATED APPLICATION

This application claims priority to Chinese Patent Application Serial Number 202220881293.9 filed on Apr. 15, 2022, the entirety of which is incorporated by reference herein.

### TECHNICAL FIELD

The present disclosure generally relates to the field of single pair Ethernet connectors. More specifically, the present disclosure relates to an anti-removal device for a single pair Ethernet connector assembly.

### BACKGROUND

With the rapid development of industrial Internet of Things, single pair Ethernet is attracting more and more attention. Single pair Ethernet is an advanced and simple form of Ethernet connection, which can transmit data and power using only a pair of copper wires and provide reliable and efficient communication. Therefore, single pair Ethernet has such merit as simple wiring, low cost, light weight, reliability, high efficiency and ease of installation.

In some cases, it is necessary to use a single pair Ethernet connector assembly to connect single pair Ethernet cables to transmit data and power, or to extend the length of single pair Ethernet cables. A single pair Ethernet connector assembly includes a male connector and a female connector or a coupler connected to each other. A male connector can be inserted and locked in a female connector or a coupler, and can be unlocked from a female connector or a coupler by pressing an unlocking piece. However, an exposed unlocking piece may be accidentally pressed or intentionally pressed by an unauthorized user, and as a result, a male connector is unexpected unlocked and removed from a female connector or a coupler.

### SUMMARY

The present disclosure provides an anti-removal device for a single pair Ethernet connector that can overcome at least one of the aforementioned defects of products of the state of the art.

One aspect of the present disclosure relates to an anti-removal device of a single pair Ethernet connector assembly, wherein the single pair Ethernet connector assembly includes a male connector and a female connector or a couple connecting to each other; the male connector includes an elastic locking piece constructed to removably lock the male connector in the female connector or the coupler and an elastic unlocking piece constructed to unlock the male connector from the female connector or the coupler; the elastic locking piece extends backward in an angle from the top surface of the male connector; the elastic unlocking piece extends forward in an angle from the top surface of the male connector, and its free end is located right above a free end of the elastic locking piece;
the anti-removal device is constructed to prevent accidental or unauthorized removal of the male connector from the female connector or the coupler, and it includes:
a protective cover, the protective cover having a hollow box shape and having a through-hole, the protective cover being constructed to be fixated on the top surface of the male connector, the protective cover and the female connector or the coupler jointly enclosing the elastic locking piece and the elastic unlocking piece when the male connector and the female connector or the coupler are connected with each other;
a unlocking rod, the unlocking rod having an elongated shape and being able to pass through the through-hole of the protective cover to approach the elastic unlocking piece to unlock the male connector from the female connector or the coupler;
wherein the protective cover has an opening in the front end and includes a top wall, a bottom wall, and two side walls and a back wall connecting the top wall and the bottom wall, and
wherein an opening groove opened toward the front opening and a pair of hooks located at the entrance of the opening groove are set on the bottom wall of the protective cover; the pair of hooks extend inward from the side walls of the opening groove.

In some embodiments, an elastic unlocking piece includes a leg fixated on the top surface of the male connector, a substrate connected to the leg, and an elastic piece extending forward in an angle from the substrate; the opening groove is constructed to receive the leg of the elastic unlocking piece, and the pair of hooks are constructed to prevent the leg of the elastic unlocking piece from being detached from the opening groove.

In some embodiments, the horizontal cross section of the leg is configured to be smaller than the horizontal cross section of the substrate.

In some embodiments, the dimensions and shape of the opening groove are configured to match the dimensions and shape of the horizontal cross section of the leg.

In some embodiments, a tilted front surface, which is gradually reducing outward, is set at each of the pair of hooks, and the tilted front surface is constructed to guide the leg of the elastic unlocking piece into the opening groove.

In some embodiments, the top wall and side walls of the protective cover are constructed to be abutted against the top wall and side walls of the female connector or the coupler when the male connector and the female connector or the coupler are connected to each other.

In some embodiments, the outer contour of the top wall of the protective cover is configured to match the outer contour of the top wall of the female connector or the coupler, and the outer contours of the side walls of the protective cover are configured to match the outer contours of the side walls of the female connector or the coupler; thus, the protective cover and the female connector or the coupler jointly form an enclosed space to house the elastic locking piece and the elastic unlocking piece.

In some embodiments, the height of the side walls and the back wall of the protective cover is configured to be approximately the same as or greater than the height of the elastic unlocking piece.

In some embodiments, the through-hole is configured on the back wall of the protective cover, and once the protective cover is installed on the male connector, the height of the through-hole is configured to be slightly greater than the height of the connection between the substrate of the elastic unlocking piece and the elastic piece.

In some embodiments, the unlocking rod includes a handle and a rod extending forward from the handle, and the width of the handle is configured to be greater than the width of the rod.

In some embodiments, the handle has rough texture, and the rough texture is constructed to make it easy for a user to hold it without slipping.

In some embodiments, the handle has an annular shape, a circular shape, or a polygonal shape.

In some embodiments, the rod has an elongated shape and is constructed to be inserted into the through-hole of the protective cover to approach and press the free end of the elastic unlocking piece.

In some embodiments, along the longitudinal direction, the rod includes an insertable section, which can be inserted into a protective cover, and an exposed section, which cannot be inserted into the protective cover; the outer contour dimensions of the insertable section are configured to be smaller than the dimensions of the through-hole, while the outer contour dimensions of the exposed section are configured to be greater than the dimensions of the through-hole.

In some embodiments, the longitudinal length of the insertable section is configured to be smaller than the longitudinal length of the protective cover.

In some embodiments, a stopper is set on the rod between the insertable section and the exposed section, and the stopper is constructed to prevent the rod from being excessively inserted into the protective cover.

In some embodiments, the shape and dimensions of the vertical cross section of the insertable section are configured to match the shape and dimensions of the through-hole.

In some embodiments, the through-hole is designed to have a rough T shape, a rough L shape, and a rough rectangular shape.

In some embodiments, the insertable section includes a guide section, which protrudes from the center, the left section, or the right section of the body; the guide section is constructed to guide the rod through the through-hole of a rough T shape or a rough L shape to enter into the interior of a protective cover.

In some embodiments, the guide section extends longitudinally through the entire rod.

A connector assembly can include a single pair Ethernet connector including: a pair of electrical contacts; an elastic locking piece configured to engage with a surface of a second connector; and an elastic unlocking piece configured to engage with the elastic locking piece. The connector assembly can further include a protective cover having a hollow box shape and having a through-hole, the protective covering the elastic unlocking piece; and a unlocking rod having an elongated shape and being able to pass through the through-hole of the protective cover to deflect the elastic unlocking piece to unlock the elastic locking piece from the surface of the second connector. In some examples, the single pair Ethernet connector is a simplex LC connector compliant with IEC Standard IEC 61754-20.

Other features and advantages of the subject technology of the present disclosure will be explained in the description below, and in part will be apparent from the description, or may be learned by practice of the subject technology of the present disclosure. The advantages of the subject technology of the present disclosure will be realized and attained by the structure particularly pointed out in the written Specification and Claims hereof as well as the attached drawings.

It should be understood that both the foregoing general description and the following detailed description are exemplary and explanatory and are intended to provide further explanation of the subject technology of the present disclosure as claimed.

### BRIEF DESCRIPTION OF THE DRAWINGS

A plurality of aspects of the present disclosure will be better understood after reading the following specific embodiments with reference to the attached drawings.

FIGS. 1A and 1B show three-dimensional views of a single pair Ethernet connector assembly in a separated state and a combined state.

FIGS. 2A and 2B respectively show a three-dimensional view and an exploded cross-sectional view of the female connector in FIGS. 1.

FIG. 3 shows a three-dimensional view of the male connector in FIGS. 1.

FIG. 4 shows a cross-sectional view of a male connector and a female connector connected together.

FIGS. 5A-5B show a three-dimensional view and a cross section view of an anti-removal device of a single pair Ethernet connector assembly according to an embodiment of the present disclosure.

FIGS. 6A-6D show three-dimensional views and cross-sectional views of a protective cover of the anti-removal device in FIGS. 5 from different angles, respectively.

FIGS. 6E-6G show three-dimensional views of different embodiments of through-holes of a protective cover.

FIGS. 7A-7B show a front view and a three-dimensional view of an unlocking rod of the anti-removal device in FIGS. 5, respectively.

FIGS. 8-13 show operating steps of the anti-removal device in FIGS. 5, respectively.

FIGS. 14A-14B show three-dimensional views of another embodiment of a single pair Ethernet connector assembly in a separated state and a combined state.

### DETAILED DESCRIPTION

The present disclosure will be described below with reference to the attached drawings, wherein the attached drawings illustrate certain embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that in all the attached drawings, the same symbols denote the same elements. In the attached drawings, the dimensions of certain features can be changed for clarity.

It should be understood that the words in the Specification are only used to describe specific embodiments and are not intended to limit the present disclosure. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The words “comprise”, “contain” and “have” used in the Specification indicate the presence of the claimed features, but do not exclude the presence of one or more other features. The word “and/or” used in the Specification includes any or all combinations of one or a plurality of the related listed items. The words “between X and Y” and “between approximate X and Y” used in the Specification shall be interpreted as including X and Y. As used herein, the wording “between approximate X and Y” means “between approximate X and approximate Y”, and as used herein, the wording “from approximate X to Y” means “from approximate X to approximate Y”.

In the Specification, when it is described that an element is “on” another element, “attached” to another element, “connected” to another element, “coupled” to another element, or “in contact with” another element, etc., the element may be directly on another element, attached to another element, connected to another element, coupled to another element, or in contact with another element, or an intermediate element may be present. In contrast, if an element is described “directly” “on” another element, “directly attached” to another element, “directly connected” to another element, “directly coupled” to another element or “directly in contact with” another element, there will be no intermediate elements. In the specification, a feature that is arranged “adjacent” to another feature, may denote that a feature has a part that overlaps an adjacent feature or a part located above or below the adjacent feature.

In the Specification, words expressing spatial relations such as “upper”, “lower”, “left”, “right”, “front”, “rear”, “top”, and “bottom” may describe the relation between one feature and another feature in the attached drawings. It should be understood that, in addition to the locations shown in the attached drawings, the words expressing spatial relations further include different locations of a device in use or operation. For example, when a device in the attached drawings rotates reversely, the features originally described as being “below” other features now can be described as being “above” the other features. The device may also be oriented by other means (rotated by 90 degrees or at other locations), and at this time, a relative spatial relation will be explained accordingly.

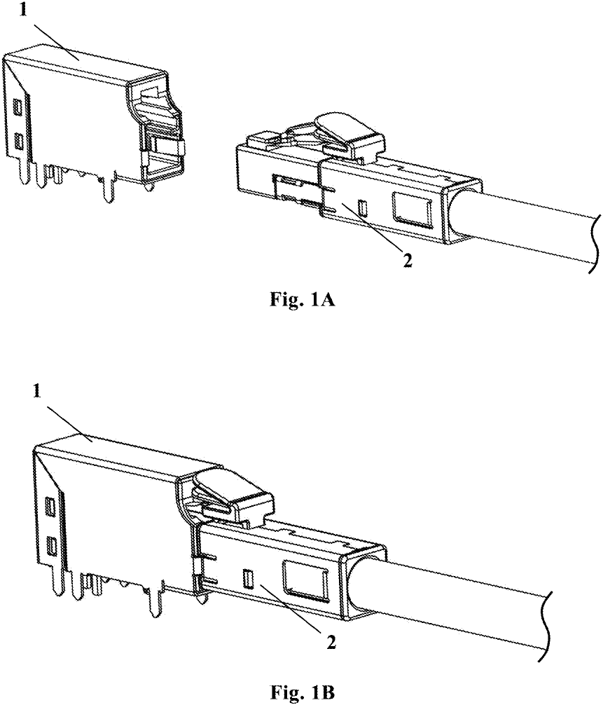

FIG. 1A and FIG. 1B separately show three-dimensional views of a single pair Ethernet connector assembly in a separated state and a combined state respectively. As shown in the figures, the connector assembly includes a female connector 1 and a male connector 2, each having a pair of electrical contacts, connected together, wherein the male connector 2 is removably inserted into the female connector 1 for connection and locking. A single pair Ethernet connector assembly can be used together with various active devices or passive devices, including but not limited to patch panels, wall sockets, Ethernet switches, routers, servers, and Ethernet power supply equipment, etc. A female connector 1 may be located on a cabinet, a rack, or other infrastructure, and a male connector 2 is connected to a single pair Ethernet cable. An example connector having features usable with the anti-removal features of this disclosure is shown and described in U.S. Pat, 11,362,463, entitled “Connectors and contacts for a single twisted pair of conductors”, the entirety of which is incorporated by reference herein. In some examples the connector can be a simplex LC connector and can be compliant with the IEC (International Electrotechnical Commission) standard for an LC connector, identified as IEC 61754-20, the noted IEC standard is hereby incorporated by reference.

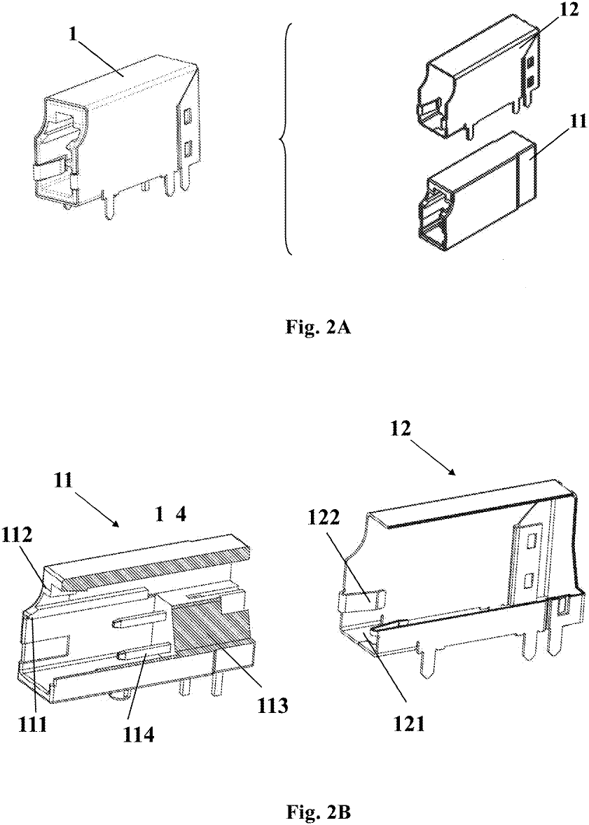

FIGS. 2A and 2B show a three-dimensional view and an exploded cross-sectional view of a female connector 1. As shown in the figures, a female connector 1 includes a housing 11 and a shield cover 12. A housing 11 has a generally hollow rectangular parallelepiped shape, and the front and rear ends are open. A terminal carrier 113 is set at the interior rear section of a housing 11 to support a terminal 114 of a female connector 1 and to keep the terminal 114 in place. Guide bars 111 are set on the front section of the interior surfaces of two opposite side walls of a housing 11. Guide bars 111 protrude inward toward the interior surfaces of side walls and extend longitudinally to guide a male connector 2 to be inserted into a female connector 1. A locking protrusion 112 is set on the front section of the interior surface of a top wall of a housing 11. A locking protrusion 112 protrudes downward from the interior surface of a top wall and extends horizontally. A locking protrusion 112 is fitted with an elastic locking piece 211 of a male connector 1 (to be described in detail below) so that a male connector 2 can be removably locked in a female connector 1.

A shield cover 12 encloses a housing 11. A shield cover 12 is made of metal to reduce the interference of external crosstalk from adjacent connectors. A shield cover 12 has a generally hollow rectangular cuboid shape; the front end is open, and the rear end is closed. Flat buckles 122 are set at the front sections of the interior surfaces of two opposite side walls of a shield cover 12. Buckles 122 may be elastically pressed against two opposite side walls of a housing 11 below guide bars 111 to fixate the housing 11 in place.

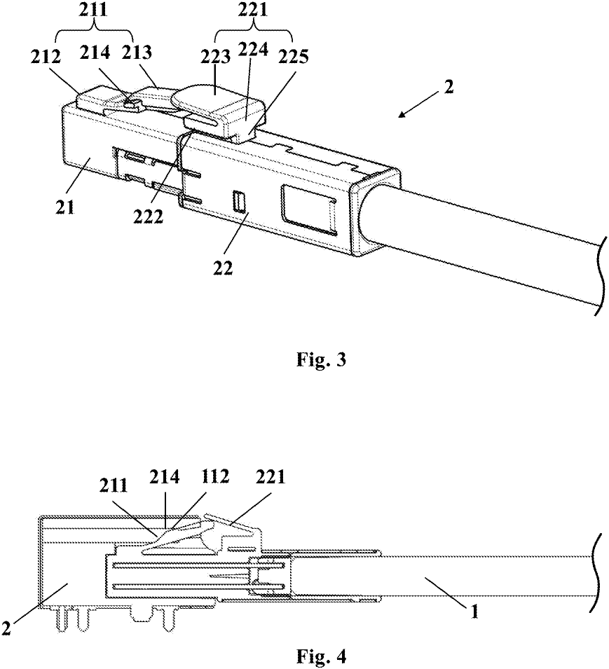

FIG. 3 shows a three-dimensional view of a male connector 2. As shown in the figures, a male connector 2 includes a terminal carrier (not shown) inside, and a housing 21 and a shield cover 22 outside. A terminal carrier is used to support a terminal of a male connector 2 (not shown) and to hold the terminal in place. A terminal carrier is further used to receive an end of a single pair Ethernet cable so as to electrically connect a conductor of the single pair Ethernet cable to a terminal of a male connector 2.

A housing 21 may be fixated to a terminal carrier of a male connector 2 in various ways. For example, a housing 21 may be entirely located in front of a terminal carrier with its rear end connected to the terminal carrier, or a rear section of a housing 21 may enclose the terminal carrier. An elastic locking piece 211 is set on a top surface of a housing 21 to removably lock a male connector 2 to a female connector 2. An elastic locking piece 211 is connected to a top surface of a housing 21 via a flexible hinge, and includes a base 212 and an elastic piece 213. A base 212 is fixated at a front section of a top surface of a housing 21, and an elastic piece 213 extends from a base 212 backward in an angle. A locking protrusion 214 is set at the connection between a free end of an elastic piece 213 and a base 212. A locking protrusion 214 protrudes upward from a top surface of an elastic piece 213 and extends horizontally. When a male connector 2 is inserted into a female connector 1, an elastic piece 213 is pressed by a housing 11 of a female connector 1 and is deformed downward; moreover, it proceeds inside the housing 11 of the female connector 1 until the locking protrusion 214 of the elastic piece 213 passes over a locking protrusion 112 of the housing 11. The locking protrusion 214 of the elastic locking piece 213 is abutted against the locking protrusion 112 of the housing 11 so that the male connector 2 and the female connector 1 are locked in place. Once a free end of the elastic piece 213 is pressed downward, the locking protrusion 214 of the elastic piece 213 can be detached from the locking protrusion 112 of the housing 11, and thus the male connector 2 is unlocked from the female connector 1.

A shield cover 22 encloses the entire terminal carrier and a rear section of a housing 21. A shield cover 22 is made of metal to reduce the interference of external crosstalk from adjacent connectors. An elastic unlocking piece 221 is set on a top surface of a shield cover 22 to be pressed against a free end of an elastic locking piece 211 to remove the lock between a male connector 2 and a female connector 1 by the elastic locking piece 211 so that the male connector 2 is removed from the female connector 1. An elastic unlocking piece 221 is connected to a top surface of a shield cover 22 via a flexible hinge, and includes a base 222 and an elastic piece 223. The base 222 includes a substrate 224 and a leg 225 below the substrate 224, and the horizontal cross section of the leg 225 is smaller than the horizontal cross section of the substrate 224. The leg 225 is used to fixate the substrate 224 at the front section of the top surface of the shield cover 22. The elastic piece 223 extends forward in an angle from a base 212, and its free end is located right above the free end of the elastic price 213; thus, pressing the free end of the elastic piece 223 downward may press the free end of the elastic piece 213 downward, which unlocks the male connector 2 from the female connector 1.

As shown in FIG. 4, when a male connector 2 and a female connector 1 are connected, a large section of an elastic locking piece 211 of the male connector 2 is received in a housing 11 and a shield cover 12 of the female connector 1, and thus its free end is exposed outside the housing 11 and the shield cover 12 of the female connector 1. An elastic unlocking piece 221 of the male connector 2 is completely exposed outside the housing 11 and the shield cover 12 of the female connector 1, and its free end is located right above the free end of the elastic locking piece 211.

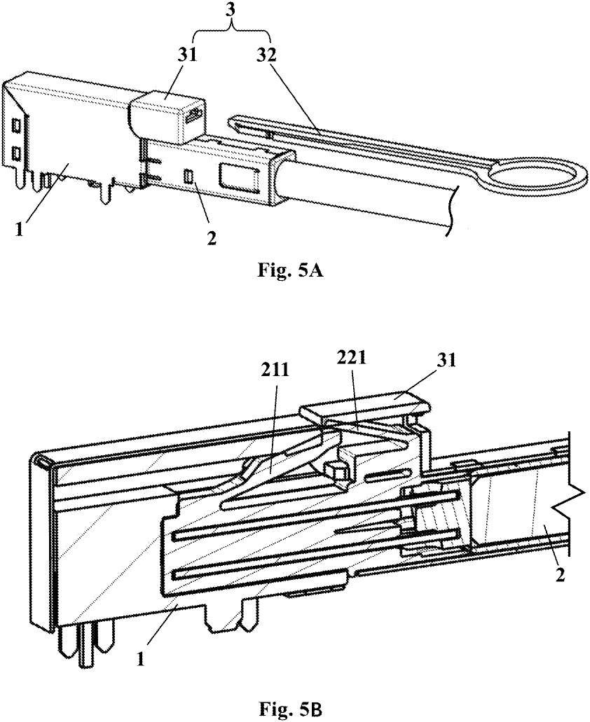

FIGS. 5A-5B show an anti-removal device 3 for a single pair Ethernet connector assembly according to an embodiment of the present disclosure. An anti-removal device 3 is used to prevent accidental or unauthorized removal of a male connector 2 from a female connector 1, and it includes a protective cover 31 and an unlocking rod 32. A protective cover 31 is used to cover the exposed free end of an elastic locking piece 211 of a male connector 2 and the entire elastic unlocking piece 221 to prevent external access to them. An unlocking rod 32 is used to press an elastic unlocking piece 221 as needed, which allows the male connector 2 to be unlocked and removed from the female connector 1.

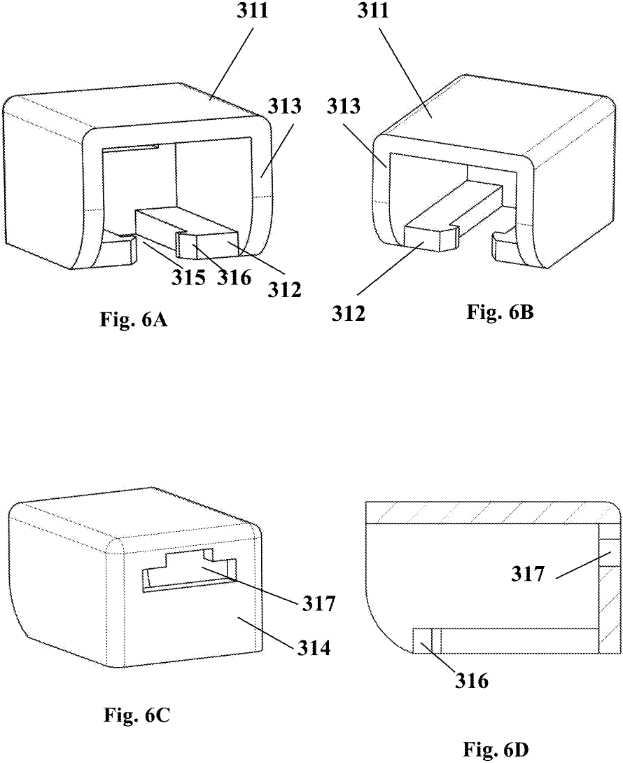

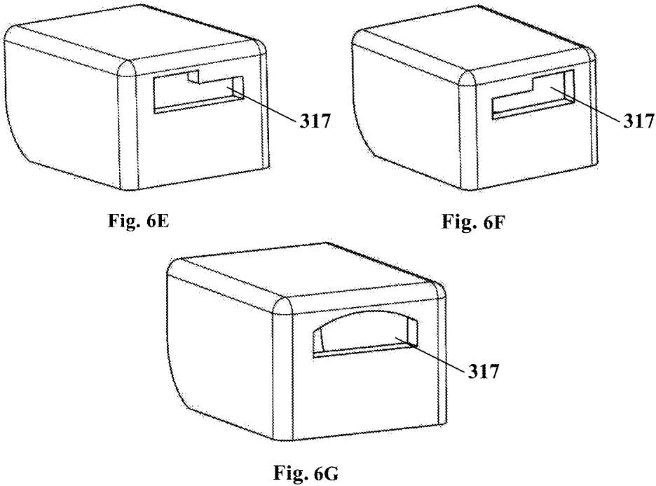

As shown in FIGS. 6A-6D, a protective cover 31 may have a hollow box shape (for example, a hollow hexahedron), and its front end is open. A protective cover 31 may include a top wall 311, a bottom wall 312, and two side walls 313 and a back wall 314, which connect the top wall 311 and the bottom wall 312.

An opening groove 315 opened forward and a pair of opposite hooks 316 located at the entrance of the opening groove 315 are set on the bottom wall 312 of a protective cover 31. The opening groove 315 is used to receive a leg 225 of an elastic unlocking piece 221 of a male connector 2. The dimensions and the shape of the horizontal cross section of the opening groove 315 match those of the leg 225, and it may have a rough rectangular shape as an example. The pair of hooks 316 extend inward from two side walls of the opening groove 315 and are used to prevent the leg 225 from being detached from the opening groove 315. In some embodiments, a tilted front surface, which is gradually reducing outward, is set at each of the pair of hooks 316, making it convenient for the leg 225 of the elastic unlocking piece 221 to be guided into the opening groove 315.

A top wall 311 and side walls 313 of a protective cover 31 are abutted against a top wall and side walls of a housing 11 and/or a shield cover 12 of a female connector 1 respectively. The outer contour of the top wall 311 of the protective cover 31 matches the outer contour of the top wall of the housing 11 and/or the shield cover 12, and the outer contour of the side walls 313 of the protective cover 31 match the outer contour of the side walls of the housing 11 and/or the shield cover 12. Once the protective cover 31 is installed on the male connector 2, the height of the side walls 313 and the back wall 314 of the protective cover 31 is approximately the same as or greater than the height of the elastic unlocking piece 221. Thus, the protective cover 31 and the housing 11 and/or the shield cover 12 jointly form an enclosed space to house an elastic locking piece 211 and an elastic unlocking piece 221 to prevent external access to the elastic unlocking piece 221, which causes accidental removal or unauthorized removal of the male connector 2 from the female connector 1.

A through-hole 317 is set on the back wall 314 of a protective cover 31 to allow an unlocking rod 32 to be inserted to the interior of a protective cover 31 to approach and press the free end of an elastic unlocking piece 221 and thus to unlock and remove a male connector 2 from a female connector 1 as needed. Once the protective cover 31 is installed on the male connector 2, the height of the through-hole 317 of the protective cover 31 is slightly greater than the height of the connection between a base 222 of an elastic unlocking piece 221 and an elastic piece 223 so that an unlocking rod 32 proceeds from the rear to above an elastic unlocking piece 221 and presses the elastic unlocking piece 221.

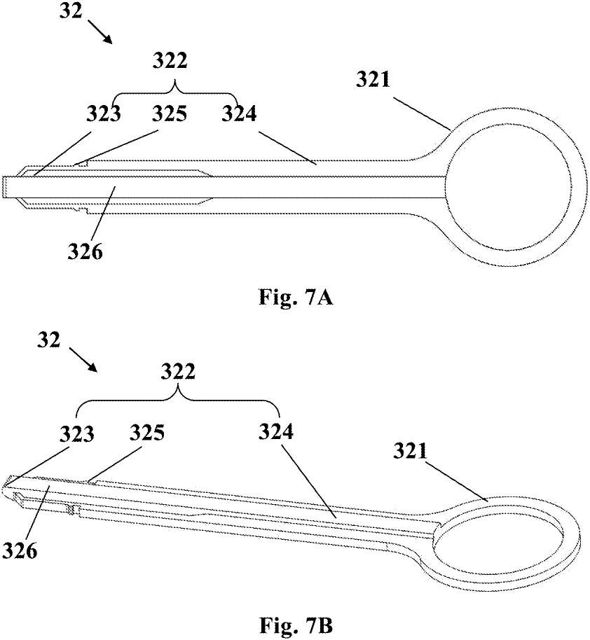

As shown in FIG. 7A and FIG. 7B, an unlocking rod 32 has a roughly elongated shape and includes a handle 321 and a rod 322 extending forward from the handle 321. The width of the handle 321 is far greater than that of the ord 322, making it convenient for a user to hold it and complete the inserting and pulling operations. In some embodiments, a handle 321 may have an annular shape, a circular shape, a polygonal shape, or any other shape that is easy to hold. In some embodiments, a handle 321 has rough texture, making it convenient for a user to firmly hold it without slipping.

A rod 322 has an elongated shape and is used to be inserted into a through-hole 317 of a protective cover 31 to approach and press a free end of an elastic unlocking piece 221. Along the longitudinal direction, the rod 322 includes an insertable section 323, which can be inserted into a protective cover 31, and an exposed section 324, which cannot be inserted into the protective cover 31. The outer contour dimensions of the insertable section 323 are smaller than the dimensions of a through-hole 317, while the outer contour dimensions of the exposed section 324 are greater than the dimensions of the through-hole 317. The longitudinal length of the insertable section 323 is smaller than the longitudinal length of the protective cover 31. A stopper 325 is set on the rod 322 between the insertable section 323 and the exposed section 324. The stopper 325 is used to prevent the rod 322 from being excessively inserted into the protective cover 31, which thus causes damage to a female connector 1, a male connector 2, and/or the protective cover 31.

In some embodiments, the shape and dimensions of the vertical cross section of an insertable section 323 match those of a through-hole 317. The through-hole 317 may be set in a rough T shape (as shown in FIG. 6C), a rough L shape (as shown in FIG. 6E and FIG. 6F), or a rough rectangle (as shown in FIG. 6G). In some embodiments, the insertable section 323 includes a guide section 326, and the guide section 326 may protrude from the center, the left section, or the right section of the body of the insertable section 323. The guide section 326 is used to guide a rod 322 through the through-hole 317 of a rough T shape or a rough L shape to enter into the interior of a protective cover 31. In some embodiments, the guide section 326 extends longitudinally through the entire rod 322.

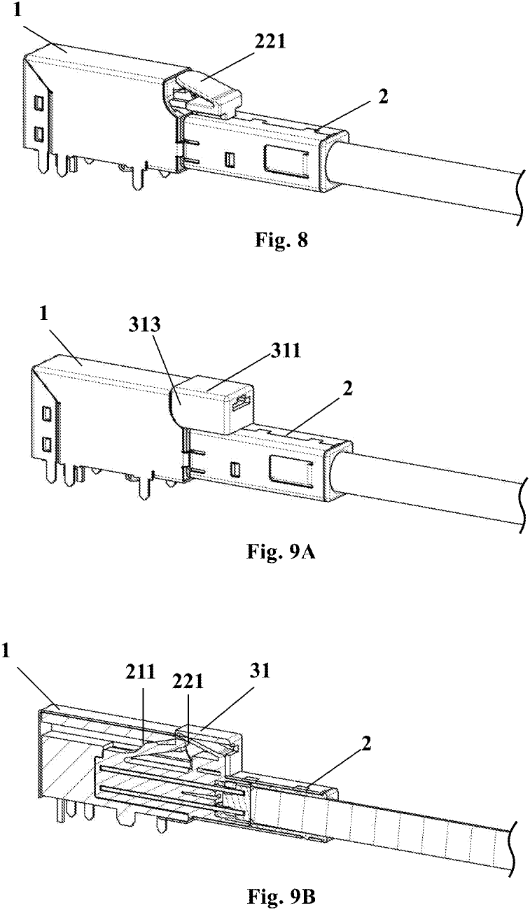

A method of using an anti-removal device 3 according to an embodiment of the present disclosure is described by referencing FIGS. 8-13. First, as shown in FIG. 8, a male connector 2 is inserted into a female connector 1; an elastic locking piece 211 of the male connector 2 is pressed by a housing 11 of a female connector 1 and is deformed downward, and it proceeds toward the interior of the housing 11 of the female connector 1 until a locking protrusion 214 of the elastic locking piece 211 passes over a locking protrusion 112 of the housing 11. The locking protrusion 214 of the elastic locking piece 211 is abutted against the locking protrusion 112 of the housing 11 so that the male connector 2 and the female connector 1 are locked. At this point, a large section of the elastic locking piece 211 of the male connector 2 is received in the housing 11 and a shield cover 12 of the female connector 1, and thus its free end is exposed outside the housing 11 and the shield cover 12 of the female connector 1. An elastic unlocking piece 221 of the male connector 2 is completely exposed outside the housing 11 and the shield cover 12 of the female connector 1, and its free end is located right above the free end of the elastic locking piece 211.

As shown in FIG. 9A and FIG. 9B, a protective cover 31 is placed on the top surface of a male connector 2, located at the rear of an elastic unlocking piece 221. The protective cover 31 is pushed forward so that the hooks 316 of its bottom wall 312 are slightly expanded, pass over a leg 225 of an elastic unlocking piece 221 of the male connector 2, and then are restored to the original shape so that the leg 225 is received and fixated in an opening groove 315 of the bottom wall 312. A top wall 311 and side walls 313 of a protective cover 31 are abutted against a top wall and side walls of a housing 11 and/or a shield cover 12 of a female connector 1 respectively. At this point, the elastic unlocking piece 221 of the male connector 2 is enclosed in the protective cover 31 to prevent external access. The protective cover 31 can be mounted in position on male connector 2 before the male connector 2 is inserted and latched into the female connector 1, or the protective cover 31 can be added after insertion and latching.

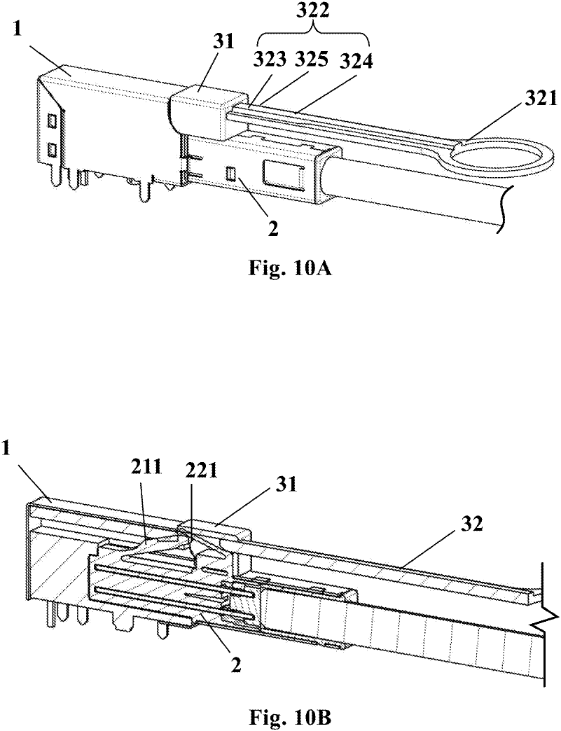

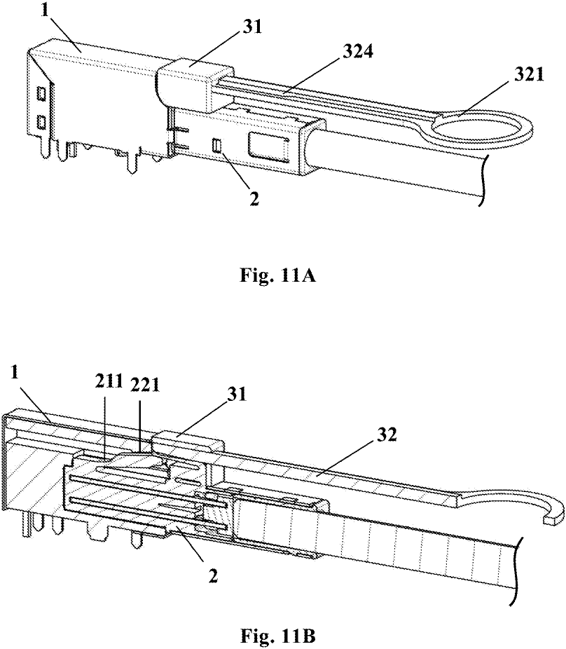

As shown in FIG. 10A and FIG. 10B, when a male connector 2 has to be removed from a female connector 1, a handle 321 of an unlocking rod 32 is held, and a rod 322 of the unlocking rod 32 is inserted into a through-hole 317 of a protective cover 31. The unlocking rod 32 is pushed forward; an insertable section 323 of the rod 322 gradually presses down an elastic unlocking piece 221 of the male connector 2 and then continues to press down an elastic locking piece 211 of the male connector 2. The unlocking rod 32 is pushed until its stopper 325 is abutted against a back wall 314 of the protective cover 31; at this point, a locking protrusion 214 of an elastic locking piece 211 already moves downward until it is free of contact with a locking protrusion 112 of the female connector 1, and thus the lock between the male connector 2 and the female connector 1 is removed, as shown in FIG. 11A and FIG. 11B.

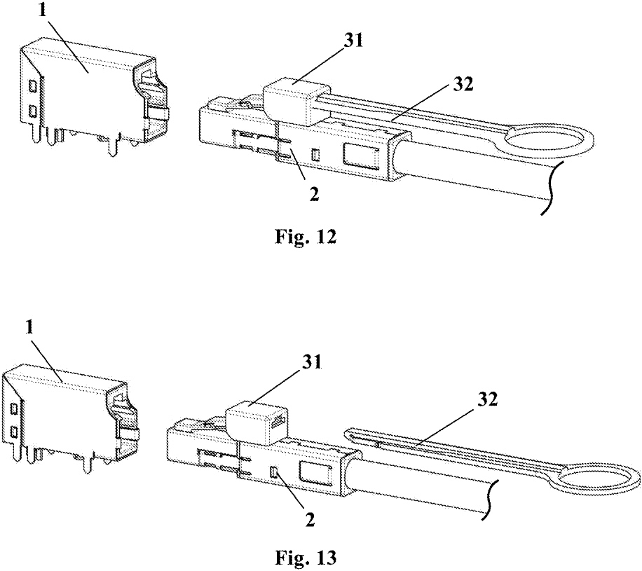

As shown in FIG. 12, a shield cover 22 of a male connector 2 is held, and the male connector 2 is pulled in the direction away from a female connector 1 so that the male connector 2 is removed from the female connector 1. Finally, as shown in FIG. 13, an unlocking rod 32 is removed from a protective cover 31, and thus the operation of removing the male connector 2 from the female connector 1 is completed.

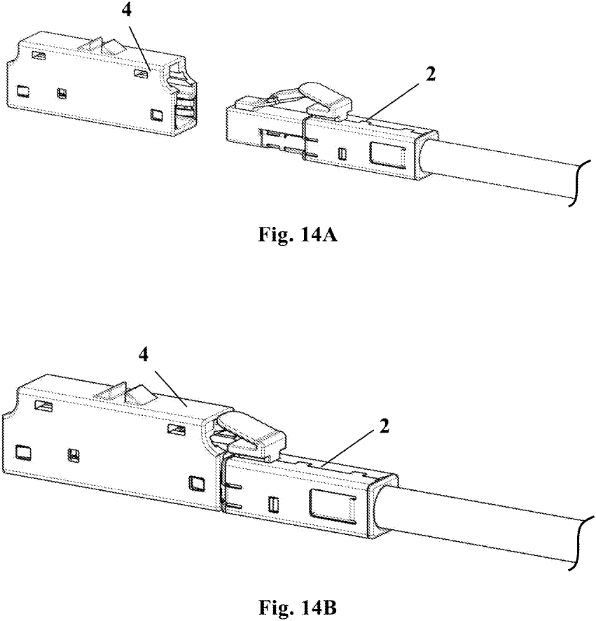

An anti-removal device according to an embodiment of the present disclosure can be used for a single pair Ethernet connector assembly including a female connector and a male connector and a single pair Ethernet connector assembly including a coupler and male connectors. FIG. 14A and FIG. 14B show a single pair Ethernet connector assembly including a coupler 4 and male connectors 2. There are openings at both ends of the coupler 4 to receive two male connectors 2 and to electrically connect two male connectors 2. The connection and locking method between each end of the coupler 4 and a male connector 2 is similar to those of a female connector, and thus it is not repeated.

An anti-removal device according to an embodiment of the present disclosure can be easily installed to a single pair Ethernet connector assembly without changes to the original structure of the single pair Ethernet connector assembly.

An anti-removal device according to an embodiment of the present disclosure can effectively prevent accidental removal or detachment of a male connector from a female connector or a coupler of a single pair Ethernet connector assembly.

An anti-removal device according to an embodiment of the present disclosure has a simple structure and low cost, and can be widely used in various corporate and consumer markets.

### Additional Aspects

Aspect 1: An anti-removal device of a single pair Ethernet connector assembly, wherein the single pair Ethernet connector assembly includes a male connector and a female connector or a couple connecting to each other; the male connector includes an elastic locking piece constructed to removably lock the male connector in the female connector or the coupler and an elastic unlocking piece constructed to unlock the male connector from the female connector or the coupler; the elastic locking piece extends backward in an angle from the top surface of the male connector; wherein the elastic unlocking piece extends forward in an angle from the top surface of the male connector, and its free end is located right above a free end of the elastic locking piece; and the anti-removal device is constructed to prevent accidental or unauthorized removal of the male connector from the female connector or the coupler, and it includes: a protective cover, the protective cover having a hollow box shape and having a through-hole, the protective cover being constructed to be fixated on the top surface of the male connector, the protective cover and the female connector or the coupler jointly enclosing the elastic locking piece and the elastic unlocking piece when the male connector and the female connector or the coupler are connected with each other; an unlocking rod, the unlocking rod having an elongated shape and being able to pass through the through-hole of the protective cover to approach the elastic unlocking piece to unlock the male connector from the female connector or the coupler; wherein the protective cover has an opening in the front end and includes a top wall, a bottom wall, and two side walls and a back wall connecting the top wall and the bottom wall, and wherein an opening groove opened toward the front opening and a pair of hooks located at the entrance of the opening groove are set on the bottom wall of the protective cover; the pair of hooks extending inward from the side walls of the opening groove.

Aspect 2: The anti-removal device of Aspect 1, wherein an elastic unlocking piece includes a leg fixated on the top surface of the male connector, a substrate connected to the leg, and an elastic piece extending forward in an angle from the substrate; the opening groove is constructed to receive the leg of the elastic unlocking piece, and the pair of hooks are constructed to prevent the leg of the elastic unlocking piece from being detached from the opening groove.

Aspect 3: The anti-removal device of Aspect 2, wherein a horizontal cross section of the leg is configured to be smaller than a horizontal cross section of the substrate.

Aspect 4: The anti-removal device of Aspect 2, wherein the dimensions and shape of the opening groove are configured to match the dimensions and shape of the horizontal cross section of the leg.

Aspect 5: The anti-removal device of Aspect 2, wherein a tilted front surface, which is gradually reducing outward, is set at each of the pair of hooks, and the tilted front surface is constructed to guide the leg of the elastic unlocking piece into the opening groove.

Aspect 6: The anti-removal device of Aspect 1, wherein the top wall and side walls of the protective cover are constructed to be abutted against the top wall and side walls of the female connector or the coupler when the male connector and the female connector or the coupler are connected to each other.

Aspect 7: The anti-removal device of Aspect 6, wherein the outer contour of the top wall of the protective cover is configured to match the outer contour of the top wall of the female connector or the coupler, and the outer contours of the side walls of the protective cover are configured to match the outer contours of the side walls of the female connector or the coupler; thus, the protective cover and the female connector or the coupler jointly form an enclosed space to house the elastic locking piece and the elastic unlocking piece.

Aspect 8: The anti-removal device of Aspect 1, wherein the height of the side walls and the back wall of the protective cover is configured to be approximately the same as or greater than the height of the elastic unlocking piece.

Aspect 9: The anti-removal device of Aspect 2, wherein the through-hole is configured on the back wall of the protective cover, and once the protective cover is installed on the male connector, the height of the through-hole is configured to be slightly greater than the height of the connection between the substrate of the elastic unlocking piece and the elastic piece.

Aspect 10: The anti-removal device as described in any of Aspects 1-9, wherein the unlocking rod includes a handle and a rod extending forward from the handle, and the width of the handle is configured to be greater than the width of the rod.

Aspect 11: The anti-removal device of Aspect 10, wherein the handle has rough texture, and the rough texture is constructed to make it easy for a user to hold it without slipping.

Aspect 12: The anti-removal device of Aspect 10, wherein the handle has an annular shape, a circular shape, or a polygonal shape.

Aspect 13: The anti-removal device of Aspect 10, wherein the rod has an elongated shape and is constructed to be inserted into the through-hole of the protective cover to approach and press the free end of the elastic unlocking piece.

Aspect 14: The anti-removal device of Aspect 10, wherein along the longitudinal direction, the rod includes an insertable section, which can be inserted into the protective cover, and an exposed section, which cannot be inserted into the protective cover; and the outer contour dimensions of the insertable section are configured to be smaller than the dimensions of the through-hole, while the outer contour dimensions of the exposed section are configured to be greater than the dimensions of the through-hole.

Aspect 15: The anti-removal device of Aspect 14, wherein the longitudinal length of the insertable section is configured to be smaller than the longitudinal length of the protective cover.

Aspect 16: The anti-removal device of Aspect 14, wherein a stopper is set on the rod between the insertable section and the exposed section, and the stopper is constructed to prevent the rod from being excessively inserted into the protective cover.

Aspect 17: The anti-removal device of Aspect 14, wherein the shape and dimensions of the vertical cross section of the insertable section are configured to match the shape and dimensions of the through-hole.

Aspect 18: The anti-removal device of Aspect 17, wherein the through-hole is designed to have a rough T shape, a rough L shape, or a rough rectangular shape.

Aspect 19: The anti-removal device of Aspect 14, wherein the insertable section includes a guide section, which protrudes from the center, the left section, or the right section of a body; the guide section is constructed to guide the rod through the through-hole of a rough T shape or a rough L shape to enter into the interior of a protective cover.

Aspect 20: The anti-removal device of Aspect 19, wherein the guide section extends longitudinally through the entire rod.

Although the exemplary embodiments of the present disclosure have been described, it should be understood by those of ordinary skill in the art that a plurality of variations and changes can be created and made to the exemplary embodiments of the present disclosure without essentially departing from the spirit and scope of the present disclosure. Therefore, all variations and changes are included in the protection scope of the present disclosure defined by the claims. The present disclosure is defined by the attached claims, and equivalents of these claims are also included.

What is claimed is:

1. An anti-removal device comprising:
a single pair Ethernet connector assembly including a male connector and a female connector, wherein the male connector includes an elastic locking piece constructed to removably lock the male connector in the female connector or the coupler and an elastic unlocking piece constructed to unlock the male connector from the female connector or the coupler, wherein the elastic locking piece extends backward in an angle from a top surface of the male connector, wherein the elastic unlocking piece extends forward in an angle from the top surface of the male connector and a free end of the elastic unlocking piece is located directly above a free end of the elastic locking piece;
wherein the anti-removal device is constructed to prevent accidental or unauthorized removal of the male connector from the female connector or the coupler, and includes:
a protective cover, the protective cover having a hollow box shape and having a through-hole, the protective cover being constructed to be fixated on the top surface of the male connector, the protective cover and the female connector or the coupler jointly enclosing the elastic locking piece and the elastic unlocking piece when the male connector and the female connector or the coupler are connected with each other; and
an unlocking rod, the unlocking rod having an elongated shape and being able to pass through the through-hole of the protective cover to approach the elastic unlocking piece to unlock the male connector from the female connector or the coupler;
wherein the protective cover has an opening in the front end and includes a top wall, a bottom wall, and two side walls and a back wall connecting the top wall and the bottom wall, and
wherein an opening groove opened toward the front opening and a pair of hooks located at the entrance of the opening groove are set on the bottom wall of the protective cover, the pair of hooks extend inward from the side walls of the opening groove.

2. The anti-removal device of claim 1, wherein the elastic unlocking piece includes a leg fixated on the top surface of the male connector, a substrate connected to the leg, and an elastic piece extending forward in an angle from the substrate, wherein the opening groove is constructed to receive the leg of the elastic unlocking piece, and the pair of hooks are constructed to prevent the leg of the elastic unlocking piece from being detached from the opening groove.

3. The anti-removal device of claim 2, wherein a horizontal cross section of the leg is configured to be smaller than a horizontal cross section of the substrate.

4. The anti-removal device of claim 2, wherein the dimensions and shape of the opening groove are configured to match the dimensions and shape of a horizontal cross section of the leg.

5. The anti-removal device of claim 2, wherein a tilted front surface, which is gradually reducing outward, is set at each of the pair of hooks, and the tilted front surface is constructed to guide the leg of the elastic unlocking piece into the opening groove.

6. The anti-removal device of claim 1, wherein the top wall and side walls of the protective cover are constructed to be abutted against the top wall and side walls of the female connector or the coupler when the male connector and the female connector or the coupler are connected to each other.

7. The anti-removal device of claim 6, wherein an outer contour of the top wall of the protective cover is configured to match an outer contour of the top wall of the female connector or the coupler, and outer contours of the side walls of the protective cover are configured to match outer contours of the side walls of the female connector or the coupler; thus, the protective cover and the female connector or the coupler jointly form an enclosed space to house the elastic locking piece and the elastic unlocking piece.

8. The anti-removal device of claim 1, wherein a height of the side walls and the back wall of the protective cover is configured to be approximately the same as or greater than a height of the elastic unlocking piece.

9. The anti-removal device of claim 2, wherein the through-hole is configured on the back wall of the protective cover, and once the protective cover is installed on the male connector, a height of the through-hole is configured to be slightly greater than a height of the connection between the substrate of the elastic unlocking piece and the elastic piece.

10. The anti-removal device of claim 1, wherein the unlocking rod includes a handle and a rod extending forward from the handle, and a width of the handle is configured to be greater than a width of the rod.

11. The anti-removal device of claim 10, wherein the handle has an annular shape, a circular shape, or a polygonal shape.

12. The anti-removal device of claim 10, wherein the rod has an elongated shape and is constructed to be inserted into the through-hole of the protective cover to approach and press a free end of the elastic unlocking piece.

13. The anti-removal device of claim 10, wherein along the longitudinal direction, the rod includes an insertable section, which can be inserted into a protective cover, and an exposed section, which cannot be inserted into the protective cover, wherein outer contour dimensions of the insertable section are configured to be smaller than the dimensions of the through-hole, while outer contour dimensions of the exposed section are configured to be greater than the dimensions of the through-hole.

14. The anti-removal device of claim 13, wherein a longitudinal length of the insertable section is configured to be smaller than a longitudinal length of the protective cover.

15. The anti-removal device of claim 13, wherein a stopper is set on the rod between the insertable section and the exposed section, and the stopper is constructed to prevent the rod from being excessively inserted into the protective cover.

16. The anti-removal device of claim 13, wherein the shape and dimensions of a vertical cross section of the insertable section are configured to match the shape and dimensions of the through-hole.

17. The anti-removal device of claim 16, wherein the through-hole is designed to have a T-shape, an L-shape, or a rectangular shape.

18. The anti-removal device of claim 13, wherein the insertable section includes a guide section, the guide section constructed to guide the rod through the through-hole of a T-shape or a L-shape to enter into an interior of a protective cover.

19. A connector assembly comprising:
a) a single pair Ethernet connector including:
i) a pair of electrical contacts;
ii) an elastic locking piece configured to engage with a surface of a second connector; and
iii) an elastic unlocking piece configured to engage with the elastic locking piece;
b) a protective cover having a hollow box shape and having a through-hole, the protective covering the elastic unlocking piece; and
c) an unlocking rod having an elongated shape and being able to pass through the through-hole of the protective cover to deflect the elastic unlocking piece to unlock the elastic locking piece from the surface of the second connector.

20. The connector assembly of claim 1, wherein the single pair Ethernet connector is a simplex LC connector compliant with IEC Standard IEC 61754-20.
